(19) United States
(12) Patent Application Publication
(10) Pub. No.: US 2007/0054018 A1
(43) Pub. Date: Mar. 8, 2007

(54) Method of Improving Quality of Edible Oils

(76) Inventor: James T.C. Yuan, Boothwyn, PA (US)

Correspondence Address: Ms. Linda K. Russell;Air Liquide Intellectual Property Dept., Suite 1800, 2700 Post Oak Blvd., Houston, TX, 77056, US

(21) Appl. No.: 11/466,009

(22) Filed: Aug. 21, 2006

Related U.S. Application Data
(60) Provisional application No. 60/714,173, filed on Sep. 2, 2005.

(51) Int. Cl. A23C 15/14

(52) U.S. Cl. 426/417

(57) ABSTRACT

Method and apparatus for treating an edible oil during a frying process in a vessel. In one embodiment, a hydrogen (H₂) enriched gas mixture is provided into the vessel during the frying process.

### CROSS-REFERENCE TO RELATED APPLICATIONS

This application claims the benefit under 35 U.S.C. § 119(e) to provisional application No. 60/714,173, filed Sep. 2, 2005, the entire contents of which are incorporated herein by reference.

### BACKGROUND

1. Field of the Invention

The invention relates to the improvement of edible oils used during the processing of fried food products, more specifically to a method of minimizing free radical formation and oxygen concentration in edible oil by adding a hydrogen enriched gas mixture to the oil.

2. Description of the Related Art

Frying has long been a popular method of cooking, and more than 50% of food consumed in U.S. restaurants is fried. Deep frying is a cooking method whereby food is submerged in an edible oil. The hot edible oil heats and steams the water within the food, allowing the food to be cooked. The correct frying temperature depends on the thickness and type of food, and a typical frying temperature lies between 175 and 190° C. (345-375° F.). Edible oils play an important role in the frying process, and the quality of edible oils determines the quality of finished fried foods.

Many efforts have been made to improve the quality of cooking oil used in frying processes. However, most of these efforts have focused on quality improvement in the oil production and storage stage. For example, the inhibition of oxidation effects during processing, manufacturing, and storage of cooking oil using noble gas sparging has been proposed. Non-condensable inert gas, such as nitrogen, has been used to deodorize edible oils during the storage stage. As another example, trisyl silica has been used to improve stability and quality in edible oil refining. Also, oxygen absorbers have been added into the headspace and/or into the oil phase of oil to prevent lipid auto-oxidation.

In addition to quality improvement in cooking oil during production and storage, efforts have been made to improve cooking oil quality during its working life (i.e. during a frying process). Few technologies have been developed to slow down the degradation of cooking oil during its working life. Filtration technology has been used to improve recycled cooking oil quality by lowering free fatty acid (FFA) content. Cooking oil has been treated with magnesium silicate oil and at least one alkali material such as calcium hydroxide to reduce free fatty acids content and extend the working life. Edible oils have also been treated by addition of natural antioxidants. Antioxidants, such as butylated hydroxyanisole (BHA) and butylated hydroxytoluene (BHT), have been used to reduce oxidation and rancidity of cooking oil during the heating process. Nevertheless, the methods mentioned above have proven to be marginally effective. The use of the filtration system to remove free fatty acids may not be effective due to the large size of free fatty acids. Also, adding chemicals such as antioxidants into cooking oil at high temperature brings up the concern of potential carcinogenic derivatives.

The main factors causing edible oil degradation during cooking are lipolysis and oxidation. Lipolysis is the hydrolysis of ester bonds in lipids, and it occurs by enzymatic action, or by heat and moisture, resulting in the liberation of free fatty acids. The release of short-chain fatty acids by hydrolysis in cooking oils is responsible for the rancid flavor development. Furthermore, free fatty acids developed in the course of frying are more susceptible to oxidation and produce off-colors. Lipolysis is a primary reaction occurring during deep-fat frying due to the large amounts of water from the food, and the relatively high temperatures at which cooking oil is maintained. Lipid oxidation is another major cause of edible oil degradation. The reaction with molecular oxygen (O₂) is the main reaction involved in oxidative deterioration of lipids. During frying, air, which contains 20.9% oxygen, is introduced into the cooking oil as foods are constantly added into oil. In conditions of high temperature and agitation, lipid oxidation occurs rapidly, and thus cooking oil quality deteriorates and its working life shortens.

Abusing the frying oil with overheating, excessive use or undue exposure to air while hot leads to formation of oxidation products, polymers and other deleterious compounds such as acrylamide. Acrylamide, a genotoxic carcinogen, may be formed in high concentration when carbohydrate-rich (starch-rich) foods are fried in cooking oil. Carbohydrate-rich foods include rice, potatoes, and cereals. The US Environmental Protection Agency currently classifies acrylamide as a “medium hazard probable human carcinogen”. Acrylamide is linked to gene mutations leading to cancer, including breast and uterine cancer, and tumors in the adrenal glands and internal lining of the scrotum. It is known to produce neurotoxic effects in humans and many experimental animals. Even though the mechanisms of the acrylamide formation in foods are not clear at this time, the presence of free radicals and oxygen is speculated to be one of the causes.

In order to improve the quality and enhance the safety of fried foods using cooking oil, a process of treating cooking oil during its use would be a prudent practice. Therefore, a method is needed to extend the working life of cooking oil, and reduce the food safety risk of fried foods by minimizing free radical formation and oxygen presence in cooking oil.

### SUMMARY

Aspects of the invention generally provide a method of minimizing free radical formation and oxygen concentration in edible oil by adding reducing agents to the oil during a frying process. In one embodiment, the invention provides a method for treating an edible oil in a vessel during a frying process, comprising providing a hydrogen (H₂) enriched gas mixture to the edible oil in the vessel during the frying process.

In another embodiment, the invention provides a method for treating an edible oil in a vessel during a frying process, comprising providing a hydrogen (H₂) enriched gas mixture and one or more inert gases to the edible oil in the vessel during the frying process.

In another embodiment, the invention provides an apparatus for treating an edible oil during a frying process, comprising a vessel containing an edible oil and adapted for carrying out the frying process in which food items are fried, and a H₂ enriched gas source in fluid communication with the vessel.

In another embodiment, the invention provides an apparatus for treating an edible oil during a frying process, comprising a vessel containing an edible oil and adapted for carrying out the frying process in which food items are fried, a H₂ enriched gas source in fluid communication with the vessel, and one or more inert gas sources in fluid communication with the vessel.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 exhibits the main processing steps entailed by the embodiments of the invention.

FIG. 2 shows an apparatus according to another embodiment of the invention.

FIG. 3 shows an apparatus according to another embodiment of the invention.

### Description of Preferred Embodiments

The words and phrases used herein should be given their ordinary and customary meaning in the art by one skilled in the art unless otherwise further defined.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Edible oil plays an important role in the frying process, and its quality determines the quality of finished fried foods. Abusing the frying oil with overheating, excessive use or undue exposure to air while hot leads to formation of oxidation products, polymers and other deleterious compounds such as acrylamide. The main factors causing edible oil degradation during cooking are lipolysis and oxidation. Aspects of the invention generally provide a method of minimizing free radical formation and oxygen concentration in edible oil by adding a hydrogen enriched gas mixture to the oil during a frying process in a vessel.

Embodiments of the invention provide a means to improve cooking oil quality and extend its working life by reducing the oxidative likelihood of the cooking oil during a frying process. In one embodiment, a hydrogen enriched gas mixture is provided to a cooking oil during a cooking process. The term “working life” indicates the period of time during which the oil remains for viable for use in a frying process. In one embodiment, a means to effectively deliver a H₂ enriched gas mixture into cooking oil at a desired flow rate is provided. In one aspect, the purpose of the gas treatment is to displace oxygen, free radicals, dissolved organic compounds, undesirable volatile compounds, and moisture in cooking oil. Also, when the hydrogen enriched gas mixture is introduced, it will alter the redox (oxidation-reduction) potential of its environment, minimizing harmful oxidation reactions within the cooking oil during its working life. Embodiments of the invention involve providing the hydrogen enriched gas mixture continuously or during constant intervals into the cooking oil during a frying process. By reducing the oxidative likelihood of the cooking oil during a frying process, the oxidative likelihood of the fried food products will also be reduced.

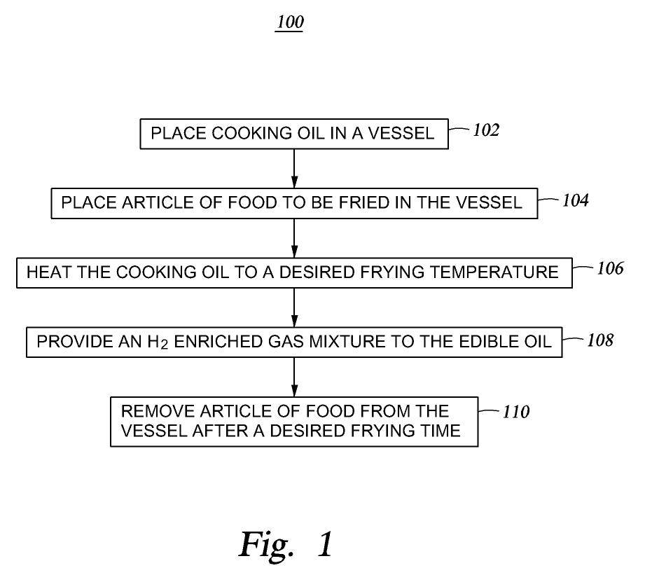

FIG. 1 is a flow diagram of a process 100, according to one embodiment of the present invention. The process 100 includes a processing step 102 involving a placement of a cooking oil in a vessel and a processing step 104 involving a placement of an article of food in the vessel. Processing step 106 involves heating the cooking oil to a desired frying temperature. Processing step 108 involves an injection of a H₂ enriched gas mixture into the edible oil in the vessel. Another embodiment of the invention includes an alternative processing step 108 involving an injection of a H₂ enriched gas mixture and one or more inert gases into the vessel. The process 100 further includes a processing step 110 involving a removing the article of food from the vessel after a desired frying time.

The processing steps 102-110 according to the embodiments of the invention are described below. The embodiments described herein are provided to illustrate the invention and the particular embodiments shown should not be used to limit the scope of the invention.

The first processing step 102 of the invention involves placement of a cooking oil in a vessel. Cooking oils that can be used in embodiments of this processing step include (but are not limited to) any edible oils that are liquids at room temperature. Examples include olive oil, soybean oil, canola oil, corn oil, sunflower oil, safflower oil, peanut oil, grape seed oil, safflower oil, cashew oil, sesame oil, argan oil, coconut oil, and rice bran oil. The next processing step 104 involves placing an article of food in the vessel containing the cooking oil. Any type of vessel may be employed in the invention. A particular embodiment involves the use of a commercial deep fryer, consisting of an aluminum or stainless steel vat. The food product to be fried can remain submerged in the vessel by any type of support. In one embodiment, the food is placed in a stainless steel basket which remains suspended in the vessel, allowing all surfaces of the food product to be exposed to the cooking oil.

The cooking oil can be heated to a desired frying temperature in processing step 106 using a variety of possible heating methods including the use of a hot plate or heater found in commercial deep-fryers. A H₂ enriched gas mixture is then injected into the vessel from a gaseous H₂ source in processing step 108. In one embodiment, the H₂ source is connected to a porous sparger located beneath the food product undergoing the frying process. Porous spargers allow gaseous H₂ to enter the vessel in the form of bubbles and diffuse throughout the solution containing the edible oil. The flow rate of the gas depends on the load of the food products. Gaseous H₂ can be sparged through the solution for an appropriate time according to the size of food product to be fried and volume of cooking oil to be treated. The range can vary between a few milliliters per minute to several liters per minute. In one embodiment, H₂ gas at room temperature is sparged through the solution in the vessel at a rate of 5 ml per minute.

Various blends of gases containing H₂ can be introduced into the vessel. In particular embodiments, hydrogen enriched gas mixtures containing up to 10% H₂ can be used, and a more particular embodiment of the invention involve the injection of 4% H₂. When the cooking oil is temporarily not being used, the flow rate of gas treatment can be reduced or eliminated. Continuous gas treatment includes the provision of the gas mixture into the cooking oil in a continuous motion or in constant intervals. Once the cooking oil is purged, the gas treatment can be stopped until it is needed again. In another embodiment, a H₂ enriched gas mixture and a cooking oil can be pre-mixed to create a hydrogenated fluid. This hydrogenated fluid can be provided to a vessel during the frying process for a given treatment time. In yet another embodiment, H₂ gas can be provided to a vessel with cooking oil by diffusion through a membrane in contact with the cooking oil.

One or more inert gases may be provided to the vessel from a source to help tune and maintain the partial pressure and alter properties such as the concentration of the injected gaseous H₂. The one or more inert gases can be pre-mixed with a H₂ enriched gas mixture in a separate vessel and injected together, or injected separately into the vessel. The inert gases that can be used include, for example, H₂, O₂, NO, N₂O, N₂, He, Ar, Kr, Xe, and various combinations and ratios thereof.

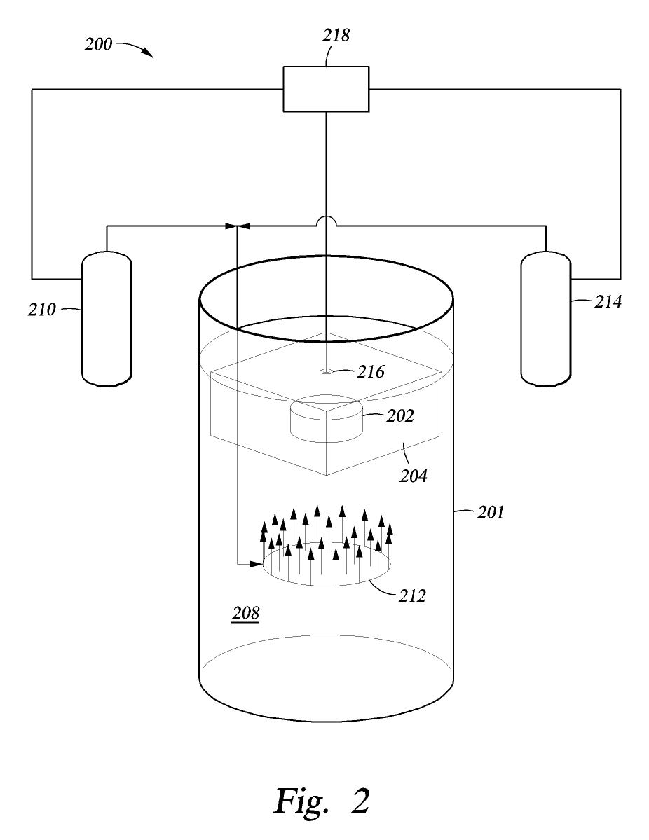

FIG. 2 shows an apparatus 200 according to one embodiment of the invention. An article of food 202 is immersed and suspended in a basket 204 in a vessel 201 containing a cooking oil 208. A gaseous H₂ source 210 is connected to a sparger 212 through which H₂ bubbles are able to enter the solution in the vessel. An inert gas source 214 is also connected to the sparger in this embodiment. In a particular embodiment, the sparging flow from the sparger 212 can be controlled with a gas flow regulator and rotameter to avoid over-foaming or bubbles in the vessel 201. The inert gas can be premixed with H₂ before entering the vessel, or injected separately. One embodiment can employ an automated gas mixer (such as is available from PBI Dansensor, of Glen Rock, N.J.) to mix one or more inert gases and H₂ enriched gas from separate cylinders in a vessel or storage container. The gas mixture can then be verified in this embodiment using a food package analyzer (such as is available from Servomex, Inc., of Sugar Land, Tex.) or gas chromatograph. The gas mixture can be contained in a buffer vessel and then released to the vessel containing the cooking oil.

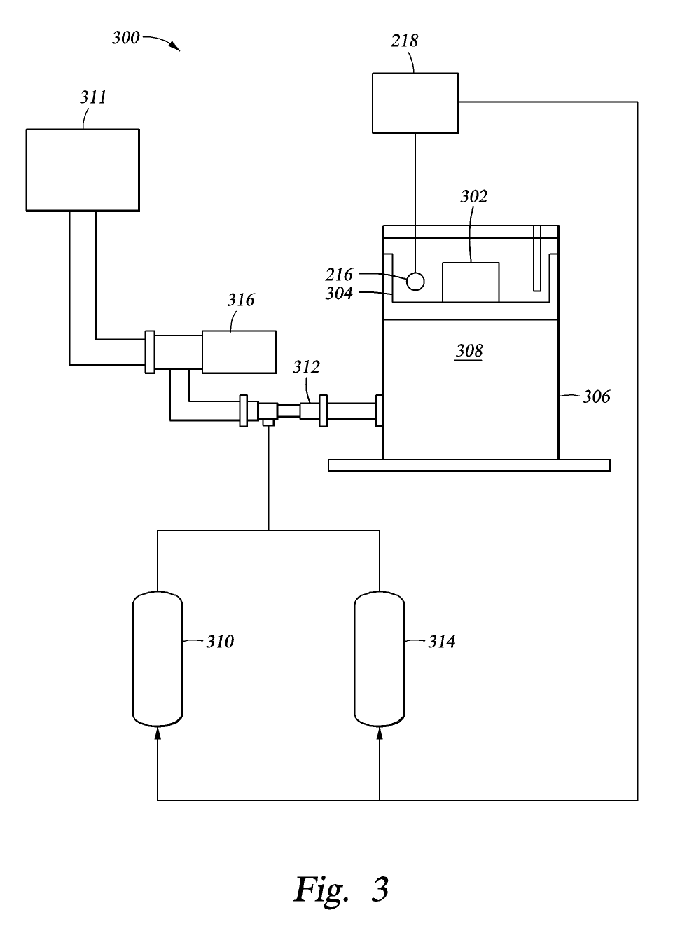

Other embodiments may be used to provide a hydrogen enriched gas mixture to a cooking oil. FIG. 3 shows an apparatus 300 according to an additional embodiment of the invention. An article of food 302 is immersed and suspended in a basket 304 in a vessel 306 containing a cooking oil 308. A gaseous H₂ source 310 is connected to a venturi tube or venture system 312 through which H₂ bubbles are able to enter the solution in the vessel. The apparatus, as shown in FIG. 3, is a tubular setup. In this embodiment, cooking oil from a source 311 is supplied to a pump 316 which pumps cooking oil into a venture system 312 of two venturi tubes. To avoid undue drag, a venturi system typically has an entry cone of 30 degrees and an exit cone of 5 degrees. In this embodiment, the pump 316 forces the cooking oil through a tube connected to the venture system 312 consisting of a venturi to increase the water speed (the diameter decreases), a short piece of tube with a small hole in it, and last a venturi that decreases speed (so the pipe gets wider again). Air will be sucked in through the small hole because of changes in pressure. At the end of the system, a mixture of fluid and air will appear. By connecting an H₂ source 310 and an inert gas source 314 to the venturi system 312, the tube can be used to mix gas with the cooking oil. The H₂/cooking oil mixture can then be injected into the vessel during a frying process in this particular embodiment. The flow from the venturi system 312 can be controlled with a gas flow regulator and rotameter to avoid over-foaming or bubbles in the vessel 306.

In one embodiment, the amount of H₂ in the oil may be monitored and replenished as needed. Accordingly, FIGS. 2 and 3 show the apparatus 200 and 300, respectively, equipped with a hydrogen sensor 216. The hydrogen sensor maybe communicatively coupled to a controller 218. The controller is configured with appropriate code which, when executed, causes the controller to issue control signals to valves of the gas sources (210, 214, 310, 314) and cause the gas sources to flow an appropriate amount of gas to the frying vessel. The appropriate amount of gas may be determined according to a desired amount of H₂ in the vessel, where this desired amount has been preprogrammed into the controller as a setpoint or range. In operation, the sensor collects information corresponding to the amount of H₂ in the oil during a frying process. This information is then sent from the sensor to the controller. In response to receiving the information from the sensor, the controller determines whether the amount of H₂ is at the desired level or within the desired range. If not, the controller issues control signals to one or more of the gas sources to cause an appropriate amount of H₂ to be provided to the oil. In this way a control loop monitors and regulates the amount of H₂ present in the oil during the frying process.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for treating an edible oil in a vessel during a frying process, comprising:
providing a hydrogen (H₂) enriched gas mixture to the edible oil in the vessel during the frying process.

2. The method of claim 1, wherein the H₂ enriched gas mixture comprises up to 10% H₂.

3. The method of claim 1, wherein the frying process is conducted at a temperature between about 175° C. and about 190° C.

4. The method of claim 1, wherein the H₂ enriched gas mixture is provided to the edible oil continuously.

5. The method of claim 1, wherein the H₂ enriched gas mixture is provided to the edible oil periodically.

6. A method for treating an edible oil in a vessel during a frying process, comprising:
providing a hydrogen (H₂) enriched gas mixture and one or more inert gases to the edible oil in the vessel during the frying process.

7. The method of claim 6, wherein the H₂ enriched gas mixture comprises up to 10% H₂.

8. The method of claim 6, wherein the frying process is conducted at a temperature between about 175° C. and about 190° C.

9. The method of claim 6, wherein the H₂ enriched gas mixture and inert gas is provided to the edible oil continuously.

10. The method of claim 6, wherein the H₂ enriched gas mixture and inert gas is provided to the edible oil periodically.

11. The method of claim 6, wherein the H₂ enriched gas mixture and inert gas are pre-mixed in a separate vessel.

12. The method of claim 6, wherein the one or more inert gases are selected from the group consisting of H₂, O₂, NO, N₂O, N₂, He, Ar, Kr, Xe, and combinations thereof.

13. An apparatus for treating an edible oil during a frying process, comprising:
a) a vessel containing an edible oil and adapted for carrying out the frying process in which food items are fried; and
b) a H₂ enriched gas source in fluid communication with the vessel.

14. The apparatus of claim 13, further comprising a sparger inside the vessel in fluid communication with the H₂ enriched gas source.

15. The apparatus of claim 13, further comprising a venturi tube in fluid communication with the H₂ enriched gas source.

16. The apparatus of claim 13, further comprising a diffusion membrane in communication with the H₂ enriched gas source.

17. An apparatus for treating an edible oil during a frying process, comprising:
a) a vessel containing an edible oil and adapted for carrying out the frying process in which food items are fried;
b) a H₂ enriched gas source in fluid communication with the vessel; and
c) one or more inert gas sources in fluid communication with the vessel.

18. The apparatus of claim 17, further comprising a sparger inside the vessel in fluid communication with the H₂ enriched gas source.

19. The apparatus of claim 17, further comprising a venturi tube in fluid communication with the H₂ enriched gas source.

20. The apparatus of claim 17, further comprising a diffusion membrane in communication with the H₂ enriched gas source.

21. The apparatus of claim 17, wherein the one or more inert gas sources are selected from the group consisting of an H₂ source, O₂ source, NO source, N₂O source, N₂ source, He source, Ar source, Kr source, Xe source, and combinations thereof.
